(19) United States
(12) Patent Application Publication
(10) Pub. No.: US 2026/0062986 A1
(43) Pub. Date: Mar. 5, 2026

(54) PASSIVE WATER INTRUSION MITIGATION DEVICE, SYSTEM, AND METHOD FOR SLIDING DOORS AND WINDOWS

(71) Applicant: STORM ARMOUR, INC., Miami Beach, FL (US)

(72) Inventor: Steven W. Diaz, Hollywood, FL (US)

(73) Assignee: STORM ARMOUR, INC., Miami Beach, FL (US)

(21) Appl. No.: 19/317,690

(22) Filed: Sep. 3, 2025

Related U.S. Application Data
(60) Provisional application No. 63/689,972, filed on Sep. 3, 2024.

(51) Int. Cl. E06B 7/14; E06B 1/70; E06B 3/46

(52) U.S. Cl. CPC E06B 7/14; E06B 1/70; E06B 3/4609

(57) ABSTRACT

An apparatus for siphoning accumulated water from sliding windows, door sills, and tracks can comprise (1) a tube comprising (a) a proximal end comprising an inlet; (b) a distal end comprising an outlet; (c) a crest intermediate the proximal end and the distal end; and (d) a transfer section intermediate the crest and the distal end. The apparatus is configured such that the accumulated water passively traverses through the tube via the inlet, through the crest, through the transfer section, and out of the apparatus via the outlet.

### CROSS-REFERENCE TO RELATED APPLICATIONS

This application claims the benefit of U.S. Provisional Application Ser. No. 63/689,972, filed Sep. 3, 2024, entitled PASSIVE WATER INTRUSION MITIGATION DEVICE, SYSTEM, AND METHOD FOR SLIDING DOORS AND WINDOWS, which is hereby incorporated in its entirety by this reference.

### FIELD OF THE INVENTION

The present invention generally relates to water intrusion mitigation devices and, more specifically, to a passive water intrusion mitigation device, along with related systems and methods, particularly configured for use with sliding doors and windows.

### BACKGROUND OF THE INVENTION

Reducing water intrusion into structures is a critical priority in building design and construction. Post-disaster surveys have consistently shown that damage and property losses from wind-driven water are often due to the failure of building fenestration components, such as sliding doors and windows, to prevent such intrusion. These failures frequently originate at the tracks of sliding doors and windows, which are particularly vulnerable to water accumulation and intrusion during high wind and rainfall events.

Devices and methods for mitigating wind-driven water intrusion require careful consideration in both new construction projects and when retrofitting existing buildings in regions prone to extreme weather conditions. Currently, water intrusion mitigation systems typically involve integrated features within the tracks of sliding doors or windows, such as weep holes. These holes allow nominal amounts of water to drain through vertically oriented openings between the tracks into a cavity within the sill. The sill usually contains one or more horizontally oriented holes or slots on its outer face to facilitate the passage of water. While these integrated systems can be effective at draining water accumulated during normal rainfall events, they often fail to provide adequate drainage under high wind and heavy rainfall conditions, leading to wind-driven water intrusion.

Existing examples of detachable, non-integrated water intrusion mitigation systems attempt to reduce water accumulation through physical barriers placed either on the exterior or interior of the sliding door or window. While these devices may effectively inhibit water accumulation or intrusion through physical blockage, they lack a mechanism to drain excess water that may accumulate in the track despite the presence of these barriers.

During high wind and rainfall events, two factors significantly increase the likelihood of water intrusion beneath sliding door or window systems. First, in heavy rain, the rate at which water enters and accumulates in the track can exceed the drainage capacity of the weep or drainage holes. Second, dynamic wind pressure acting on the exit plane of the horizontal weep holes can prevent water from draining altogether. This phenomenon, combined with the high wind pressure on the surface of the accumulated water, forces water between the door panels and the tracks, and through the interior weep holes, into the structure.

The problem to be solved is the inadequate drainage of water from the tracks of sliding doors and windows during high wind and heavy rainfall events. Current systems, such as integrated weep holes, often fail to drain water effectively under these extreme conditions, leading to wind-driven water intrusion and subsequent interior damage. Existing detachable devices provide physical barriers but lack mechanisms for removing accumulated water, thereby failing to address the root cause of water intrusion under such circumstances. As a result, there is a need for a system that not only blocks water but also actively enhances drainage to prevent intrusion.

Therefore, there is a need in the art for a water intrusion mitigation device, as well as, a related system and method, that enhances and facilitates drainage of accumulated water from the tracks under these conditions.

There is also a need in the art for such a device and system that could be used independently or in combination with other detachable water intrusion mitigation systems.

There is a further need in the art for the device and system to automatically facilitate water drainage from the tracks of sliding doors and windows without the need for electrical power, mechanical pumps, or manual intervention.

### SUMMARY OF THE INVENTION

We disclose and discuss here a passive water intrusion mitigation device, as well as related systems and methods, that enhance and facilitate drainage of accumulated water from the tracks during high wind and heavy rainfall events without the need for electrical power, mechanical pumps, or manual intervention. Embodiments of the present invention preferably disclose an apparatus for siphoning accumulated water from sliding window and door sills and tracks in the form of an inverted U-shaped tube with a proximal end and a distal end where the inlet of the tube is at the proximal end followed by an uptake portion, then a crest and transfer section extending towards the distal end, leading to a discharge portion, and an outlet at the distal end.

The tube apparatus is configured such that the inlet can be positioned in a track at a first elevation and the outlet is positioned outside the track at a lower elevation. In terms of relative vertical elevations, the crest is configured to be at the highest elevation with the inlet below the crest and the outlet below the inlet.

The present invention includes a passive water intrusion mitigation system specifically designed for sliding doors and windows, providing a significant advancement in the field of building fenestration, particularly for structures exposed to high wind and rainfall events. The invention addresses the shortcomings of current water intrusion mitigation systems by introducing a passive siphon-based drainage apparatus and related system that enhances the removal of water accumulated in the tracks of sliding doors and windows, thereby reducing the risk of wind-driven water intrusion and subsequent interior damage.

During a rainfall event, water accumulates in the tracks or sills of sliding doors or windows. As water levels rise, the siphon tube's inlet, which is positioned within the track, becomes submerged. For siphoning to begin, the siphon tube must first be primed, meaning that it needs to be filled with water. This could occur naturally if the water level rises high enough to fill the tube, or advantageously, the apparatus is configured to prime the tube by utilizing wind to initiate the siphon action without the need for manual intervention or mechanical assistance. Specifically, the invention is configured to passively draw water into the siphon tube. By way of example, and not limitation, wind moving across the siphon outlet creates a pressure differential that primes the siphon, initiating water flow. Once primed, the system continues to operate by allowing water to flow through the siphon tube from the higher water level in the track to a lower discharge point, all driven by gravity and the pressure differential. This passive operation ensures that the invention functions autonomously during high wind and rainfall events, effectively mitigating water intrusion without requiring any active input or energy.

In storm conditions, high winds and heavy rainfall typically occur simultaneously. These conditions are ideal for wind-assisted priming because the storm itself provides both the water that needs to be drained and the wind that helps initiate the siphon. As the water rises in the track, the wind moving across the siphon outlet aids in pulling the water into the tube, eventually leading to a self-sustaining siphoning action.

By incorporating design elements like venturi structures, turbine features, or directional deflectors, embodiments of the invention take advantage of wind to initiate the siphon passively. This approach is particularly effective during storm conditions when high winds and rainfall occur together, making it a novel and practical solution for mitigating wind-driven water intrusion.

The siphon tubes are preferably constructed from durable, water-impermeable materials, such as metal, plastic, or ceramic, and can be fabricated in various cross-sectional shapes, including circular, rectangular, and elliptical, to optimize their performance. The system is designed to be modular, allowing for easy customization to fit different sliding door or window configurations, as well as to facilitate installation, maintenance, and potential retrofitting in existing structures.

In embodiments, a passive siphon system includes features at the inlet and outlet of the tube device to induce and enhance water flow through the tube. These features may include scalloped inlets, venturi or turbine-like outlets, and other aerodynamic or hydrodynamic modifications that improve the system's efficiency, even under low wind conditions.

Further embodiments of the siphon system are configured to be attached to the track of a sliding door or window using various methods, such as, but not limited to, compression clamps, expansion clamps, or other detachable mechanisms, enabling both permanent and removable installations. The modularity of the system allows for the incorporation of multiple siphon tubes in parallel, spaced across the width of the door or window track, to further enhance drainage capacity.

The invention is environmentally friendly, designed to operate without harming wildlife, and can be used independently or in conjunction with other water intrusion mitigation systems, such as those that physically block water entry. The siphon drainage system of the present invention is applicable to both new constructions and the retrofitting of existing buildings, making it a versatile solution for mitigating wind-driven water intrusion in a variety of structural settings.

Repairs, adjustments, replacement, or other modifications may be necessary to embodiments of the invention. Transport, shipping, and/or storage can also be easier with smaller components, or components that can be disassembled and reassembled, particularly if they are designed to fit or be arranged in such a way as to minimize the amount of space required. It can be advantageous for the siphon drainage system, supports, or other components to be separable. More specifically, it can be advantageous for siphon drainage system to be modular, such that they are formed of more than one section, where individual sections can be installed on or attached to the tracks independently. Additionally, the siphon drainage system can be modular and be either part of a system section or independently modular on which multiple sections can be installed.

By effectively addressing the limitations of existing drainage systems, the invention offers a practical, cost-effective solution for reducing the risk of water intrusion through sliding doors and windows during extreme weather conditions, thereby contributing to improved building resilience and longevity.

An object of the present invention is to provide a passive water intrusion mitigation system that significantly reduces the risk of wind-driven water intrusion through the tracks of sliding doors and windows, particularly during high wind and heavy rainfall events.

Another object of the present invention is to provide a siphon-based drainage system that effectively increases the drainage rate from the tracks of sliding doors and windows, thereby preventing water accumulation and subsequent interior damage.

A further object of the present invention is to offer a system that operates without the need for electrical power, mechanical pumps, or manual intervention.

An additional object of the present invention is to provide a modular and customizable siphon system that can be easily installed on both new constructions and retrofitted into existing structures, with the flexibility to accommodate various track configurations and environmental conditions.

Yet another object of the present invention is to design a water intrusion mitigation system that is environmentally friendly, causing no harm to wildlife and requiring minimal maintenance.

A further object of the present invention is to provide a system that can be used independently or in conjunction with other water intrusion mitigation devices, enhancing the overall effectiveness of water management in building fenestration systems.

An object of the present invention is to ensure that the siphon tubes are durable, lightweight, and aesthetically pleasing, making them suitable for a wide range of architectural applications.

Another object of the present invention is to mitigate the effects of dynamic wind pressure on traditional weep holes, ensuring that water drains efficiently even under adverse weather conditions.

Yet another object of the present invention is to develop a cost-effective solution for mitigating wind-driven water intrusion, offering a low payback period for property owners and developers.

An additional object of the present invention is to enhance the sustainability and resilience of buildings by reducing the risk of water intrusion damage, thereby contributing to the longevity and safety of structures in regions prone to extreme weather.

### BRIEF DESCRIPTION OF THE DRAWINGS

The accompanying figures illustrate various embodiments of the siphon system and its components. These figures are intended to provide a visual representation of the invention and are not to be considered limiting. The figures include cross-sectional views of the siphon system installed in sliding door or window tracks, isometric views showing different attachment methods, and detailed views of the siphon tube's inlet and outlet configurations.

In the accompanying figures, like reference numerals refer to identical or functionally similar elements throughout the separate views. The accompanying figures, together with the detailed description below are incorporated in and form part of the specification and serve to further illustrate various embodiments and to explain various principles and advantages all in accordance with the present invention, in which:

FIG. 1 is a cross-sectional view of a representative sliding door or window system identifying various components;

FIG. 2 is a cross-sectional view of a representative sliding door or window system under normal rain conditions;

FIG. 3 is a cross-sectional view of a representative sliding door or window system demonstrating wind-driven water intrusion;

FIG. 4 is an isometric view of a siphon water drainage system of the subject invention attached to the tracks of a sliding door or window with self-tapping screws;

FIG. 5 is a side view of a siphon system of the subject invention attached to the tracks of a sliding door or window with self-tapping screws;

FIG. 6 is an isometric view of a siphon water drainage system of the subject invention attached to the tracks of a sliding door or window by means of a compression clamp;

FIG. 7 is a side view of a siphon system of the subject invention as installation in the tracks of a sliding door or window by means of a compression clamp;

FIG. 8 is an isometric view of a siphon water drainage system of the subject invention attached to the tracks of a sliding door or window by means of an expansion clamp;

FIG. 9 is a side view of a siphon system of the subject invention as installation in the tracks of a sliding door or window by means of an expansion clamp;

FIG. 10 illustrates a siphon system installed between the tracks of a sliding door or window by means of a weighted ballast system;

FIG. 11 is a side view of a siphon system installed between the tracks of a sliding door or window by means of a weighted ballast system;

FIGS. 12A, 12B, and 12C illustrates several possible tube cross-sectional shapes (elliptical, rectangular, round);

FIGS. 13A, 13B, and 13C are detail views of the siphon inlet showing possible configurations or shapes (scalloped, flat, bent);

FIGS. 14A, 14B, 14C, and 14D are detail views of the siphon outlet showing possible configurations or shapes, including mechanisms to induce flow in the tube (flat, turbine-like, venturi-like, rotational);

FIG. 15 illustrates a siphon system installed between the tracks of a sliding door or window including with a device at the inlet to induce flow in the tube;

FIG. 16 illustrates a side view of a siphon system installed between the tracks of a sliding door or window including with a device at the inlet to induce flow in the tube;

FIG. 17 is a table showing basic wind pressure as a function wind speed;

FIG. 18 is a table showing an estimation of potential water accumulation as a function of rain rate; and

FIG. 19 is a table showing an estimation of siphon flow rates as a function of tube hydraulic diameter and water column height.

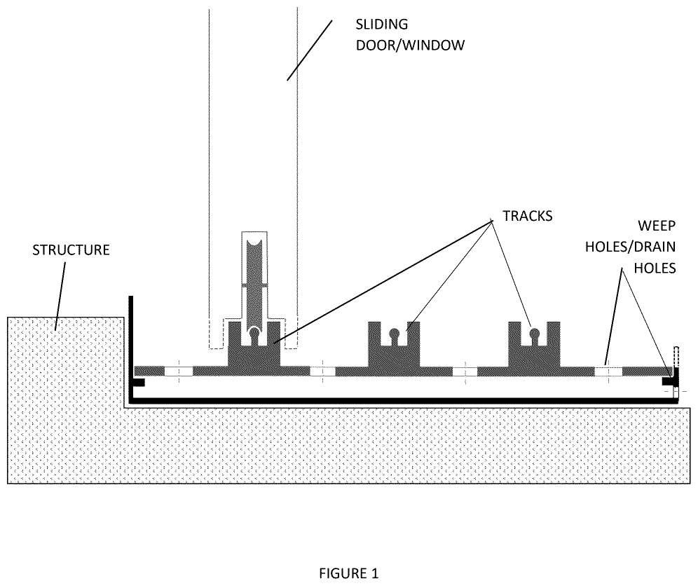

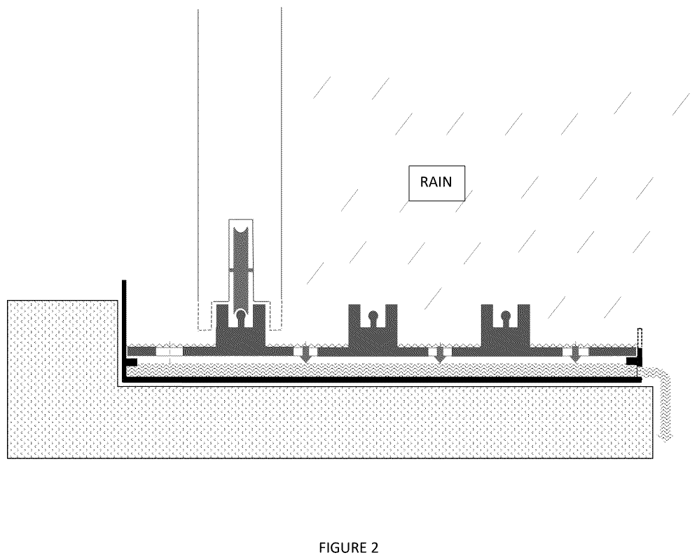

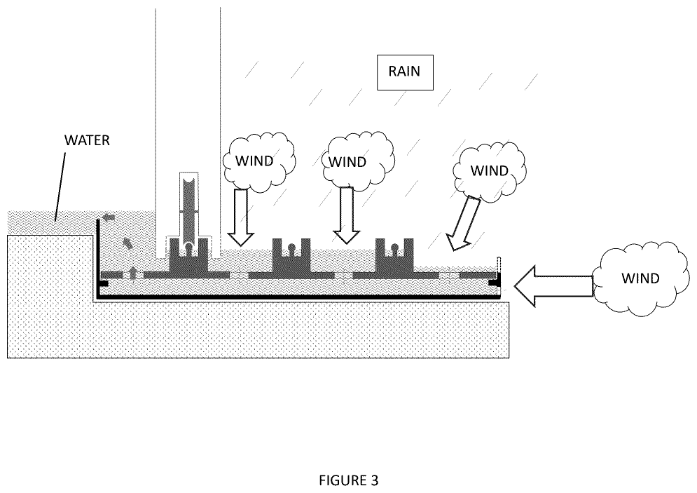

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, though an embodiment may be disclosed as including several features, other embodiments of the invention may include fewer than all such features. Thus, for example, a claim may be directed to less than the entire set of features in a disclosed embodiment, and such claim would not include features beyond those features that the claim expressly recites.

The present disclosure is not a literal description of all embodiments of the invention(s). Also, the present disclosure is not a listing of features of the invention(s) which must be present in all embodiments.

Thus, it will be appreciated that for simplicity and clarity of illustration, common and well-understood elements that are useful or necessary in a commercially feasible embodiment may not be depicted in order to facilitate a less obstructed view of these various embodiments.

### Non-Limiting Definitions.

The title of the present application and headings of sections provided in the present application are for convenience only, and are not to be taken as limiting the disclosure in any way.

The following non-limiting definitions are provided as a guide to interpreting the present invention:

The term “product” or “apparatus” means any machine, manufacture, and / or composition of matter, unless expressly specified otherwise.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an”and “the”mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of”the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget”does not cover, e.g., two widgets.

The phrase “based on” does not mean “based only on”, unless expressly specified otherwise. In other words, the phrase “based on” describes both “based only on” and “based at least on”. The phrase “based at least on”is equivalent to the phrase “based at least in part on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure”can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.”explains that “instructions”are the “data”that the computer sends over the Internet.

The term “inverted U-shaped tube” is used throughout this disclosure to refer to the passive siphon apparatus, itself. This nomenclature should not be construed as limiting in the sense that the actual shape of the apparatus need not necessarily be exactly in the shape of a letter “U” or that the cross-section be limited to any particular shape, except as defined in the claims.

The term “operates passively” or “passive” is used throughout this disclosure to refer to the functioning of the water intrusion mitigation system without the need for active mechanical components, external power sources, or manual intervention. The system relies on natural forces, such as gravity, atmospheric pressure differences, and/or environmental factors like wind, to initiate and sustain its operation.

As used herein, the term “structure” is used to refer to any type of building or infrastructure, constructed object, or form susceptible to high wind and rainfall upon fenestrations. This can include, but is not limited to, sliding doors and windows in condominiums, single-or multi-family homes, office buildings, commercial building, industrial buildings, malls, stadiums, towers, structures related to or used for transportation, or traffic (including bridges), or energy-or power-related infrastructures. This term is also not limited to any particular material, construction technique, or style and can include fenestrations that are situated upon any surface, at any orientation, or other building construction features in which water may accumulate, such as a roof parapet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including”means something other than “including but not limited to”.

### Siphon Apparatus and System Overview

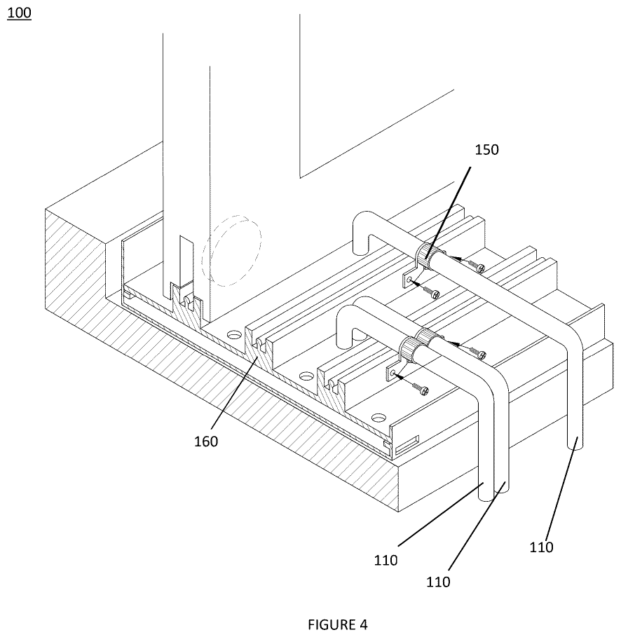

With reference to the various FIGS. 4-16, in general, and to FIG. 4 in particular, the core component of the invention is a siphon-based drainage apparatus and related system configured to remove water from the tracks of sliding doors and windows. The invention operates passively to transfer water from the track to an external discharge point. Preferably, the system 100 includes one or more tubes 110 configured to be attachable to a sill or track via one or more attachment device 150. The attachment device 150 may be a separate component or the attachment features may be integral to the tube 110 itself.

The tube 110 is an inverted U-shaped tube with a proximal end 120 and a distal end 130 where the inlet 121 of the tube 110 is at the proximal end 120 followed by an uptake portion 122, then a crest 123 and transfer section 124 extending towards the distal end 130, leading to a discharge portion 125, and an outlet 126 at the distal end 130.

The tube 110 is configured such that the inlet 121 can be positioned in a track at a first elevation 140 and the outlet 126 is positioned outside the track at a lower elevation 145. In terms of relative vertical elevations, the crest 123 is configured to be at the highest elevation 143 with the inlet 121 below the crest 123 and the outlet 126 below the inlet 121.

### Material and Tube Configuration

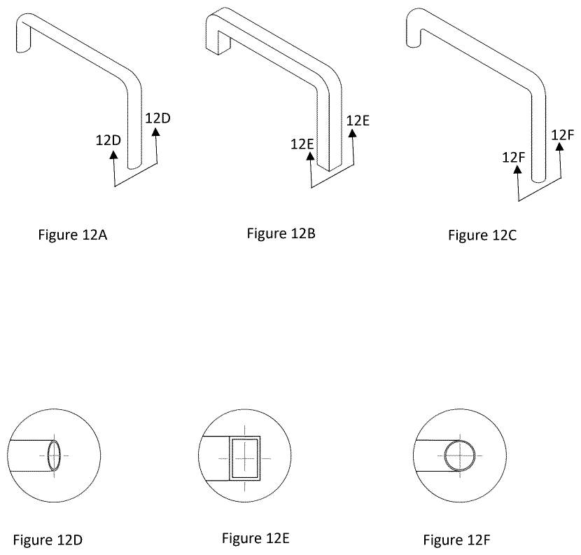

The tubes 110 are constructed from rigid or semi-rigid materials, ensuring durability and long-term performance. The tubes can have various cross-sectional shapes, such as, but not limited to, circular (FIG. 12C), rectangular (FIG. 12B), elliptical (FIG. 12A), or irregular, depending on the specific requirements of the installation. See FIGS. 12A-12B. The choice of cross-section is important, as it influences the flow characteristics of the tube and the system's overall efficiency.

By way of example, in one embodiment, the tube 110 has a flattened or elliptical cross-section, which reduces the height of the tube crest and allows for a lower profile installation. This configuration is particularly advantageous in situations where aesthetic considerations or space constraints are important. However, it will be understood by a person skilled in the art that other cross-sections or configurations can also be used with the embodiments of the subject invention.

In embodiments, the uptake may be scored or otherwise marked or modified in such a manner to facilitate cutting, bending, or breaking of the uptake to modify its length in order to provide a custom fit to a particular sliding door or window configuration so as to have the inlet fully submerged as deep as possible, while simultaneously positioning the siphon crest as low as possible (i.e., as close as possible to the level of the water surface).

The effectiveness of wind-driven water intrusion mitigation across a sliding door or window can depend, at least partially, on the diameter of the siphon tube with respect to the dimensions and configuration of the track. The dynamic pressure generated on a surface or column of water is proportional to the square of the oncoming wind speed, as shown in FIG. 16. However, a siphon system of the subject invention can be designed to take into consideration that the outlet plane of the drain tube will not be perpendicular to the direction of oncoming wind. Accordingly, the diameter of any drain tube of a siphon system will most often be determined based on the building configurations rather than the expected wind speeds.

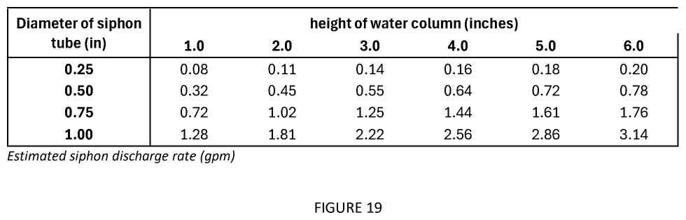

The diameter, shape, number of, and placement of the tube of a siphon system can depend upon several factors that would be understood by a person skilled in the art. For example, sliding door or window track configuration, including the door or window height, number of panels, length, width, and depth of the tracks, horizontal plan, slope, geographical direction, and other factors can dictate the size, location, and arrangement of one or more siphons on a structure. Thus, for example, the hydraulic diameter of a siphon can be between approximately ¼ inch to approximately 1 inch or more. It is possible for an siphon to have a diameter smaller than ¼ of an inch or greater than 1 inch, depending upon the structure dynamics and configuration. For example, a two-panel sliding door or window system installation can have one or more tubes with a diameter of ¼ inch or more, whereas a four-panel sliding door or window installation can have one or more drain tubes with a diameter of 1 inch or more. However, some areas of a structure could utilize a drain tube with a smaller diameter, while other areas on the same structure may benefit from a drain tube of greater diameter. Thus, the embodiments of the subject invention are not limited to a specific tube diameter. FIG. 19 shows the expected flow rates of a typical siphon as a function of tube diameter and the height of the water column. Where higher rates of water accumulation can be expected, larger siphons, or an plurality or assembly of several siphons can be employed.

### Siphon Operation

The siphon system is designed to initiate and maintain water flow using gravity and atmospheric pressure differences. When water accumulates in the track, it enters the siphon tube through the inlet. As the water level rises, it reaches the crest of the tube, where the siphoning effect begins. The water then flows through the transfer section and is discharged outside the structure through the outlet.

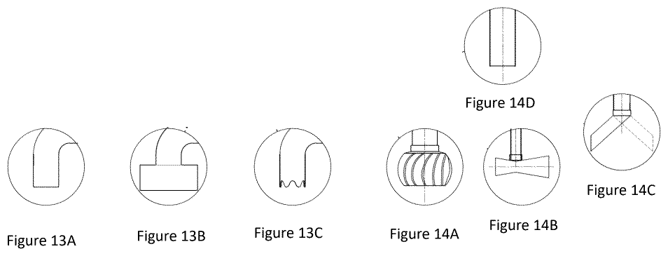

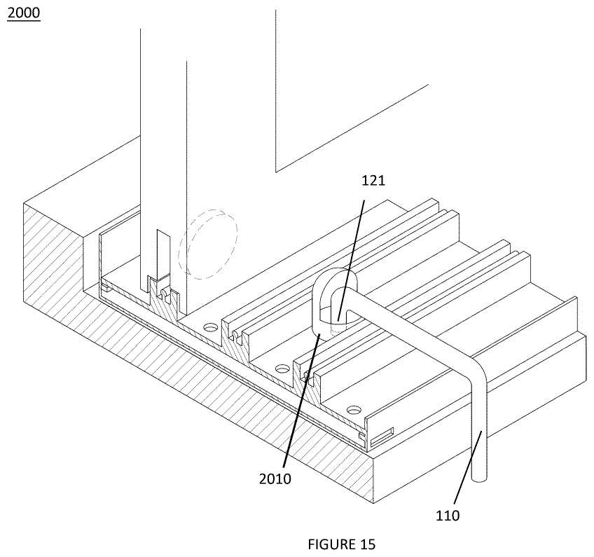

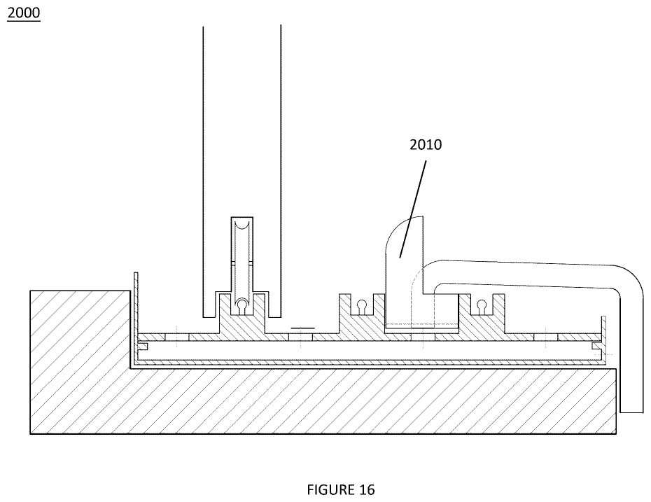

Referring now to FIGS. 13A-13C and FIGS. 14A-14C, embodiments of the invention may further include features at the inlet and outlet to induce and maintain water flow through the tube. By way of example and not limitation, the inlet entry may be configured have any of the following shapes or configurations: scalloped (FIG. 13C), cross-cut (FIG. 13A), or shaped to maximize water intake (FIG. 13B). Additionally, the outlet exit may incorporate a cross-cut configuration (FIG. 14A), a venturi configuration (FIG. 14B), a pivotal configuration (FIG. 14C), or a turbine-like configuration to passively create suction and increase flow rates through the tube, even under low wind conditions.

### Attachment and Installation

We refer now to FIGS. 4 through 11. In embodiments, the tubes 110 can be attached to the tracks 160 of sliding doors or windows using various methods and a track attachment mechanism, including, but not limited to, one or more compression clamps 162, one or more expansion clamps 164, or other detachable mechanisms. These attachment methods allow for both permanent and removable installations, making the system versatile and adaptable to different building configurations. The attachment of the siphon drain tube to the sliding door or window track can be permanent or removable, in that, the descending tube can extend directly from the outer lip, or they can be attached by various clips, clamps, pins, cams, wedges, interdigitating mechanisms and other devices and techniques known in the art. They can also be supported so that they are some distance away from the outer lip, such that there is a space between the drain tube and the outer face of the frame.

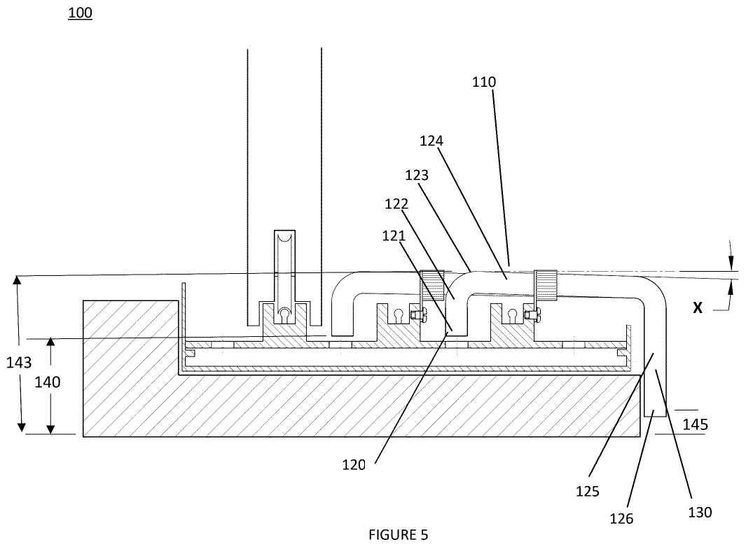

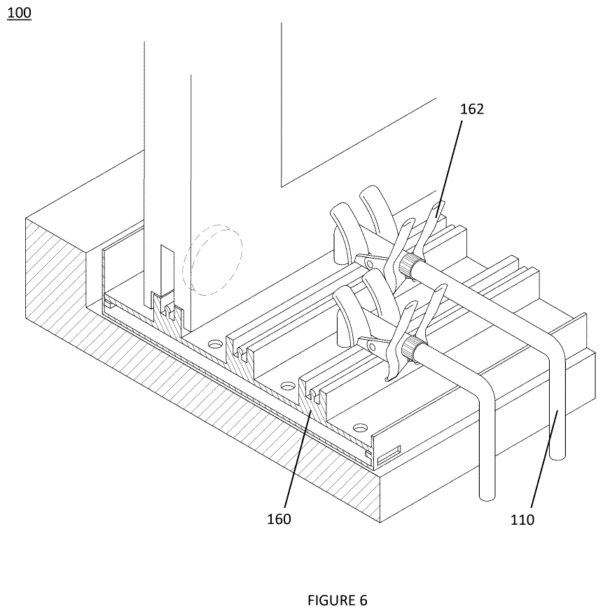

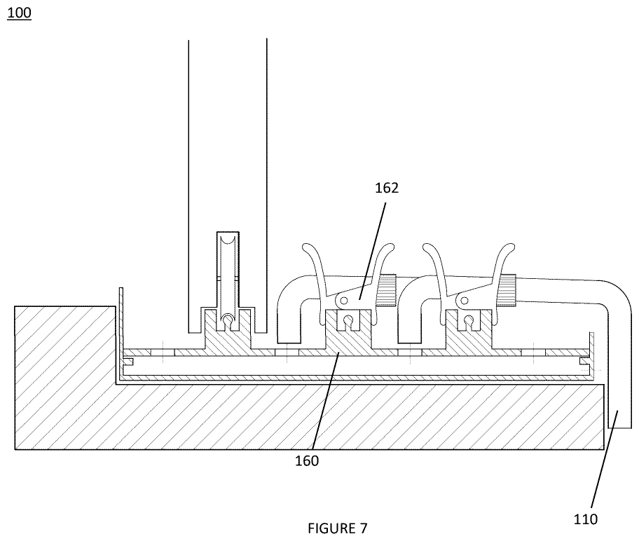

In one embodiment, the siphon tube is secured to the track using a compression clamp 162 (see FIGS. 6-7). The clamp 162 is designed to apply pressure towards the track riser or lip, ensuring a secure fit. Multiple clamps can be used along the length of the tube to provide additional stability.

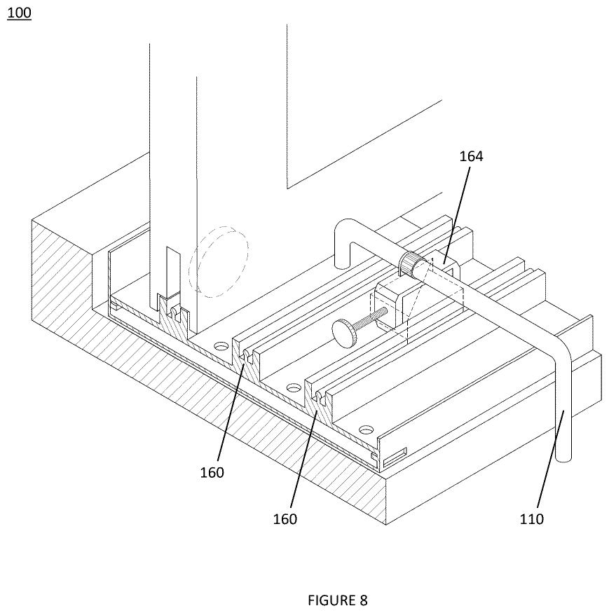

In another embodiment, see FIGS. 8-9, an expansion clamp 164 is used to secure the tube between two opposing risers or lips 160, applying outward pressure to hold the tube in place.

The modular nature of embodiments of the invention allows for customization and easy installation. Multiple tubes can be installed in spaced relation along the width of the door or window track. This configuration increases the system's overall drainage capacity and ensures efficient water removal during heavy rainfall events.

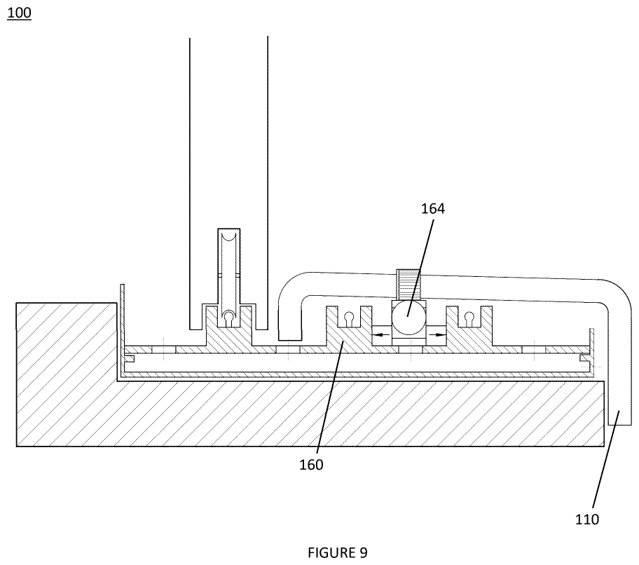

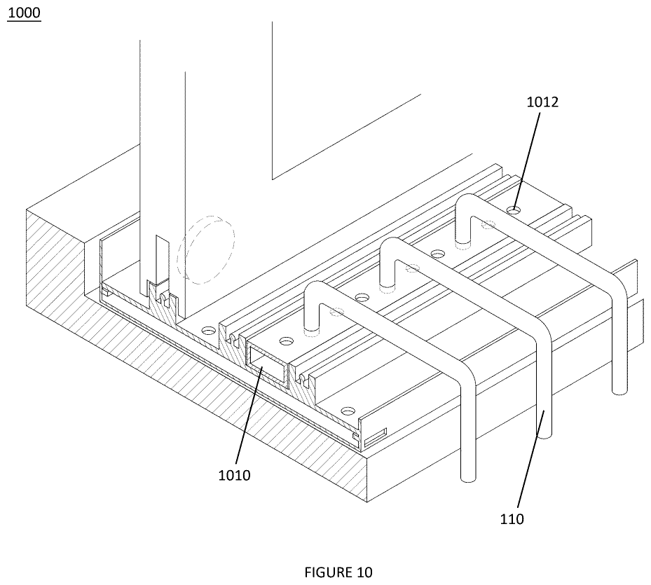

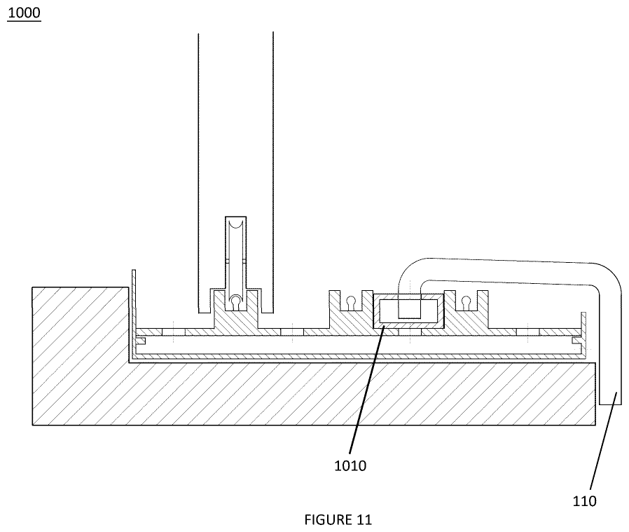

In another embodiment, see FIGS. 10-11, the tubes can be indirectly attached to the tracks by a spacer 1010 having a plurality of apertures 1012 for receiving the inlet of a tube 110.

### Environmental Considerations

The apparatus and system is designed with environmental sustainability in mind. The materials used in the construction of the tubes are preferably non-toxic and, therefore, pose no threat to wildlife. Additionally, the invention operates passively, without the need for external power sources or active mechanical components, further reducing its environmental footprint.

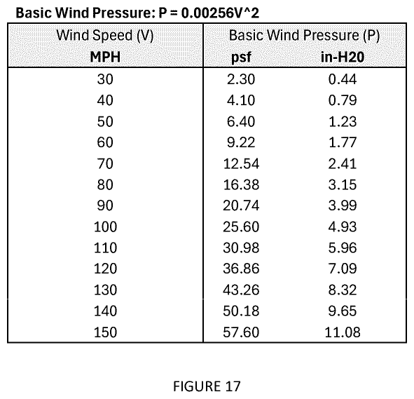

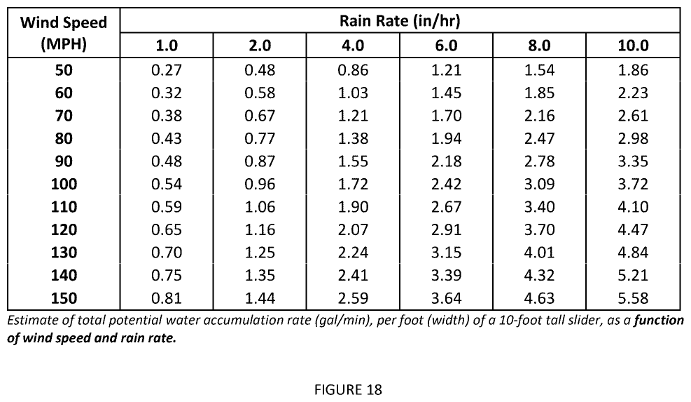

For example, FIG. 17 is a table showing basic wind pressure as a function wind speed. FIG. 18 is a table showing an estimation of potential water accumulation as a function of rain rate. FIG. 19 is a table showing an estimation of siphon flow rates as a function of tube hydraulic diameter and water column height.

### Applications

The passive water intrusion mitigation apparatus and system is applicable to both new construction and retrofitting of existing buildings. It can be used independently or in conjunction with other water intrusion mitigation devices, such as physical barriers that block water entry. The system is particularly valuable in regions prone to extreme weather conditions, where traditional drainage systems may fail to prevent water intrusion.

### Exemplary Embodiments

The various figures illustrate non-limiting exemplary embodiments of the invention depicted as installed in a typical track.

In some aspects 2000, the siphon tubes may include additional features to enhance performance. For example, such as shown in FIGS. 15-16, the inlet of the tube 121 may be equipped with a funnel-like structure 2010 to increase water intake during heavy rainfall.

In other embodiments, the outlet may further include a rotating or flexible spout to direct water flow away from the structure and prevent backflow.

Embodiments of the invention can also be integrated with other building components, such as roof parapets or drainage systems, to provide a comprehensive solution for water management. The modular design allows for easy adaptation to different building configurations and environmental conditions.

The siphon drainage system of the subject invention provides a significant improvement over current techniques for the mitigation of wind-driven water intrusion. The embodiments of the subject invention provide a structure that is better protected in adverse high wind and rainfall conditions. It is also capable of being installed in combination with other detachable systems for wind-driven water intrusion mitigation, such as those that attempt to physically deflect water away from the track, or attempt to prevent water from entering the inside of the structure by means of a physical blockage.

The description of the present application has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand various embodiments of the present invention, with various modifications as are suited to the particular use contemplated.

In light of the foregoing description, it should be recognized that embodiments in accordance with the present invention can be realized in numerous configurations contemplated to be within the scope and spirit of the claims. Additionally, the description above is intended by way of example only and is not intended to limit the present invention in any way, except as set forth in the claims.

That which is claimed is:

1. An apparatus for siphoning accumulated water from sliding windows, door sills, and tracks,
the apparatus comprising:
a tube comprising:
a proximal end comprising an inlet;
a distal end comprising an outlet;
a crest intermediate the proximal end and the distal end; and
a transfer section intermediate the crest and the distal end,
wherein the apparatus is configured such that the accumulated water passively traverses through the tube via the inlet, through the crest, through the transfer section, and out of the apparatus via the outlet.

2. The apparatus of claim 1, wherein the tube is configured to position the inlet in a track at a first elevation and to position the outlet outside of the track at a second elevation lower relative to the first elevation.

3. The apparatus of claim 2, wherein the tube comprises the crest at a highest elevation, the outlet at a lowest elevation, and the inlet at an intermediate elevation between the highest elevation and the lowest elevation.

4. The apparatus of claim 1, wherein the tube comprises an inverted U-shaped tube.

5. The apparatus of claim 1, wherein the tube further comprises an uptake portion intermediate the inlet and the crest.

6. The apparatus of claim 1, wherein the tube further comprises a discharge portion intermediate the transfer section and the outlet.

7. The apparatus of claim 1, wherein the tube has a cross-section selected from one of an oval, rectangular, and circular cross-section.

8. The apparatus of claim 1, wherein the inlet comprises an entry, the entry configured to have a configuration selected from one of a scalloped shape, a cross-cut configuration, and a maximized shape.

9. The apparatus of claim 1, wherein the outlet comprises an exit, the exit configured to have a configuration selected from one of a cross-cut configuration, a venturi configuration, a pivotal configuration, and a turbine-like configuration.

10. A method of passively mitigating water intrusion, the method comprising:
providing an apparatus for siphoning accumulated water, wherein the apparatus comprises:
a siphon tube, the siphon tube comprising an inlet and an outlet;
positioning the apparatus in a track to permit water to fill the siphon tube;
in response to the siphon tube filling with water, permitting the water to flow through the siphon tube to a lower discharge point proximate the siphon tube outlet; and permitting the passive discharge of the water through the siphon tube to the outlet.

11. The method of claim 10, wherein the siphon tube further comprises a crest intermediate the inlet and the outlet, and wherein the siphon tube further comprises a transfer section intermediate the crest and the outlet.

12. The method of claim 10, wherein positioning the apparatus in a track comprises:
positioning the tube inlet in a track at a first elevation; and
positioning the tube outlet outside of the track at a second elevation,
wherein the first elevation is higher than the second elevation.

13. The method of claim 9, wherein permitting the water to flow through the siphon tube to a lower discharge point proximate the siphon tube outlet further comprises the steps of:
positioning the siphon tube inlet in a track;
permitting a rise in water level within the siphon tube, wherein a siphoning effect begins when the water level reaches the crest; and
discharging the water from the siphon tube outlet.

14. The method of claim 10, wherein the siphon tube is constructed from a durable, water-impermeable material that is at least one of a metal, plastic, and ceramic.

15. The method of claim 10, wherein the track is at least one of a window sill track and a sliding door track.

16. A siphon drainage system configured to attach to a sliding door track, a sliding window track, a door sill, and a window sill, wherein the system comprises:
one or more detachable track attachment mechanisms configured for selectively attaching the system to a track, the track comprising a first side and a second side;
a tube comprising a first end and a second end, wherein the tube is an inverted U-shape,
wherein the first end comprises an inlet and the second end comprises an outlet,
and wherein a transfer section is intermediate the tube first end and second end,
wherein at least one track attachment mechanism selectively attaches the tube to a track; and
wherein the tube inlet is positioned in the track proximate the first side, the tube outlet is positioned outside of the track proximate the second side, and water is discharged from the track by wind moving across the tube inlet, creating a pressure differential to siphon water from the track, into the tube inlet, through the tube transfer section, and out of the tube outlet to a lower discharge point.

17. The system of claim 16, wherein the track first side has a higher elevation than the track second side.

18. The system of claim 16, wherein the track is selected from one of a window sill track and a sliding door track.

19. The system of claim 16, wherein the one or more detachable track attachment mechanisms is selected from one of a compression clamp, expansion clamp, clip, pin, cam, wedge, and interdigitating mechanism.

20. The system of claim 16, wherein the tube inlet comprises a funnel.
